(19) United States
(12) Patent Application Publication
(10) Pub. No.: US 2026/0018829 A1
(43) Pub. Date: Jan. 15, 2026

(54) CONNECTOR SOCKET, CONNECTOR, AND DEVICE

(71) Applicant: Phoenix Contact GmbH & Co., KG, Blomberg (DE)

(72) Inventors: Dejan Raic, Hummelstown, PA (US); Shane William Wiest, Shermans Dale, PA (US); Michael Anthony Correll, Hershey, PA (US)

(73) Assignee: Phoenix Contact GmbH & Co., KG, Blomberg (DE)

(21) Appl. No.: 19/041,982

(22) Filed: Jan. 30, 2025

Related U.S. Application Data
(60) Provisional application No. 63/670,721, filed on Jul. 12, 2024.

(51) Int. Cl. H01R 13/627; H01R 25/00

(52) U.S. Cl. CPC H01R 13/6271; H01R 25/006

(57) ABSTRACT

A connector socket, a connector, and a device are provided. The connector socket includes a housing that includes an internal cavity, wherein the internal cavity is configured to mate with a connector plug, and wherein the connector plug is configured to be inserted into the internal cavity to form an electrical connection with the connector socket, and a retention protrusion, configured to interfere with the connector plug to retain the connector plug in the internal cavity.

### CROSS-REFERENCE TO RELATED APPLICATION

The application is based upon and claims priority to U.S. Provisional Application No. 63/670,721 U.S. filed on Jul. 12, 2024, entitled “Connector Socket, Connector, and Device,” the entire disclosure of which is incorporated herein by reference for all purposes.

### BACKGROUND

Connectors are devices widely used in electrical and mechanical systems. To meet specific connection requirements, connectors may be used to join electrical circuits together, join networking cables to network devices or to other cables, or allow different software or hardware systems to communicate with each other.

A connector may use a plug and socket connection to enable the transfer of power, signal, or data. However, the conventional connector using a plug and socket connection has the disadvantage of short durability and lack of material selection variety. For example, some conventional connectors use a press-fit connection to join the plug and socket together. The press-fit connection relies on the friction between the mating parts to hold them securely, and therefore causes stress concentration that may lead to material failure. To ensure durability, brittle materials sensitive to stress concentrations cannot be used for the connector, which limits the material choices for the connector.

### SUMMARY

Examples of the present disclosure provide a connector socket, a connector, and a device.

According to a first aspect of the present disclosure, some embodiments provide a connector socket. The connector socket includes: a housing that includes an internal cavity, wherein the internal cavity is configured to mate with a connector plug, and wherein the connector plug is configured to be inserted into the internal cavity to form an electrical connection with the connector socket, and a retention protrusion, configured to interfere with the connector plug to retain the connector plug in the internal cavity.

According to a second aspect of the present disclosure, some embodiments provide a connector. The connector includes: a connector plug and a connector socket, the connector plug being configured to be inserted into the connector socket to form an electrical connection with the connector socket, wherein the connector socket includes: a housing that includes an internal cavity, wherein the internal cavity is configured to mate with the connector plug, and a retention protrusion, configured to interfere with the connector plug to retain the connector plug in the internal cavity.

According to a third aspect of the present disclosure, some embodiments provide a device. The device includes: a connector, configured to connect to a cable for transmitting an electrical signal, wherein the connector includes: a connector plug and a connector socket, the connector plug being configured to connect with the cable and to be inserted into the connector socket to form an electrical connection with the connector socket, wherein the connector socket includes: a housing that includes an internal cavity, wherein the internal cavity is configured to mate with the connector plug, and a retention protrusion, configured to interfere with the connector plug to retain the connector plug in the internal cavity.

### BRIEF DESCRIPTION OF THE SEVERAL VIEWS OF THE DRAWINGS

FIG. 1 is an extracted view of a connector in accordance with one or more embodiments of the present disclosure.

FIG. 2 illustrates a top view of a connector socket in accordance with one or more embodiments of the present disclosure.

FIG. 3 illustrates a right view of a connector socket in accordance with one or more embodiments of the present disclosure.

FIG. 4 illustrates a perspective view of a connector socket in accordance with one or more embodiments of the present disclosure.

FIG. 5 illustrates a front view of a connector socket in accordance with one or more embodiments of the present disclosure.

FIG. 6 illustrates a section view along the A-A line in FIG. 5 illustrating a connector socket in accordance with one or more embodiments of the present disclosure.

FIG. 7 illustrates a top view of a connector without the insertion of the connector plug in accordance with one or more embodiments of the present disclosure.

FIG. 8 illustrates a front view of a connector without the insertion of the connector plug in accordance with one or more embodiments of the present disclosure.

FIG. 9 illustrates a section view along the B-B line in FIG. 8 illustrating a connector without the insertion of the connector plug in accordance with one or more embodiments of the present disclosure.

FIG. 10 illustrates a top view of a connector with the connector plug partially inserted into the connector socket in accordance with one or more embodiments of the present disclosure.

FIG. 11 illustrates a front view of a connector with the connector plug partially inserted into the connector socket in accordance with one or more embodiments of the present disclosure.

FIG. 12 illustrates a section view along the C-C line in FIG. 11 illustrating a connector with the connector plug partially inserted into the connector socket in accordance with one or more embodiments of the present disclosure.

FIG. 13 illustrates a top view of a connector with the connector plug fully inserted into the connector socket in accordance with one or more embodiments of the present disclosure.

FIG. 14 illustrates a front view of a connector with the connector plug fully inserted into the connector socket in accordance with one or more embodiments of the present disclosure.

FIG. 15 illustrates a section view along the D-D line in FIG. 14 illustrating a connector with the connector plug fully inserted into the connector socket in accordance with one or more embodiments of the present disclosure.

FIG. 16 is a perspective view of a connector socket in accordance with one or more embodiments of the present disclosure.

FIG. 17 is a front view of a connector with the connector plug fully inserted into the connector socket in accordance with one or more embodiments of the present disclosure.

FIG. 18 is a section view along the E-E line in FIG. 17 illustrating a connector with the connector plug fully inserted into the connector socket in accordance with one or more embodiments of the present disclosure.

FIG. 19A is a perspective view of a device with the connector plug inserted into the connector socket in accordance with one or more embodiments of the present disclosure.

FIG. 19B is a perspective view of a device with the connector plug extracted from the connector socket in accordance with one or more embodiments of the present disclosure.

### DETAILED DESCRIPTION

Reference will now be made in detail to example embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the disclosure. Instead, they are merely examples of apparatuses and methods consistent with aspects related to the disclosure as recited in the appended claims.

Terms used in the present disclosure are merely for describing specific examples and are not intended to limit the present disclosure. The singular forms “one,” “the,” and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

Although terms “first,” “second,” and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while,” or “in response to . . . , it is determined that.”

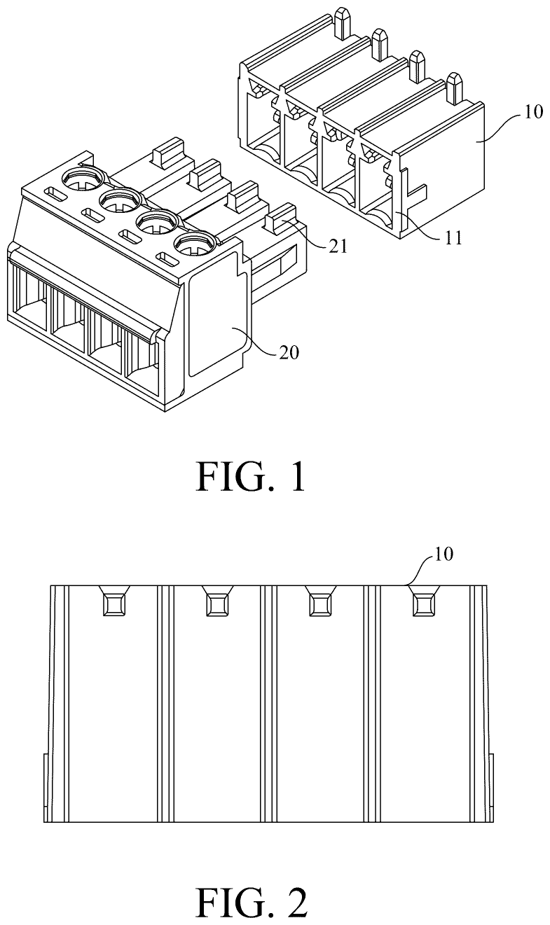

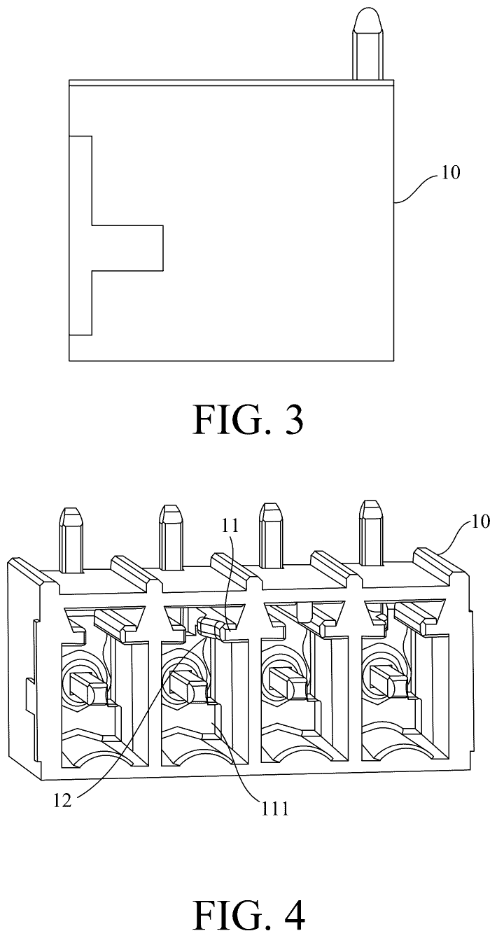

FIG. 1 is an extracted view of a connector in accordance with one or more embodiments of the present disclosure. FIGS. 2-3 respectively illustrate a top view and a right view of a connector socket 10 in accordance with one or more embodiments of the present disclosure. As shown in FIGS. 1-3, the connector includes a connector plug 20 and a connector socket 10. The connector plug 20 is configured to be inserted into the connector socket 10 to form an electrical connection with the connector socket 10. The electrical connection may be used to enable transferring power, signal, or data in an electrical or mechanical system. In some embodiments, the socket plug may be configured to connect with a cable transmitting power, signal, or data, and the connector socket 10 may be configured to connect with a circuit. After the connector plug 20 is inserted into the connector socket 10, an electrical connection is formed to transmit the power, signal, or data from the cable to the circuit. However, the type of the medium transmitted by the connector and the functionality of the connector are not limited to the embodiments of the present disclosure.

FIG. 4 illustrates a perspective view of a connector socket 10 in accordance with one or more embodiments of the present disclosure. As shown in FIG. 4, the connector socket 10 includes a housing 11 and a retention protrusion 12 disposed inside the housing 11. The housing 11 comprises an internal cavity 111, and the internal cavity 111 is configured to mate with a connector plug. The connector plug is configured to be inserted into the internal cavity 111 to form the electrical connection with the connector socket 10. The retention protrusion 12 is configured to interfere with the connector plug to retain the connector plug in the internal cavity 111. Those skilled in the art understand that the term “interfere with” in mechanical assembly field refers to that one component may be configured to block, obstruct, or interact with another component to lock the relative positions of the two components. For example, the two components may occupy overlapping space, preventing interactive movement or operation, such that the two components collide or prevent each other from moving freely. In some examples, the external dimension of one component (e.g., a shaft, or a plug) may be slightly larger than the internal dimension of the mating component (e.g., a hole, or a cavity), requiring a force for assembly or discharging. However, the interfering manner between the retention protrusion and the connector plug is not limited to the embodiments of the present disclosure.

In some embodiments, as shown in FIG. 1, the connector plug 20 may include a locking protrusion 21. When the connector plug 20 is inserted into the internal cavity 111 of the connector socket 10, the locking protrusion 21 of the connector plug 20 is interfered with by the retention protrusion 12 and therefore is retained in the internal cavity 111. However, the detailed shape and location of the retention protrusion 12 are not limited to the embodiments of the present disclosure, as long as the retention can interfere with the connector plug 20 to prevent the extraction of the connector plug 20 from the connector socket 10. In some embodiments, the locking protrusion 21 of the connector plug 20 may further be used for preventing mis-mating with a noncorresponding connector socket. The noncorresponding connector socket may have a protrusion to interfere with the locking protrusion 21 to prevent the mis-mating.

By using the retention protrusion 12 provided by embodiments of the present disclosure, since the retention protrusion 12 is disposed inside the internal cavity 111 of the connector socket 10, no outer space of the connector socket 10 is taken up, such that it can be compatible with existing connector assembly structures. In addition, since the retention protrusion 12 can function as a latch to secure the connector plug 20 in the connector socket 10, a press-fit connection is unnecessary, such that brittle materials sensitive to stress concentration can be used for producing the connector, which improves the durability of the connector, and also enlarges the choices of material for the connector.

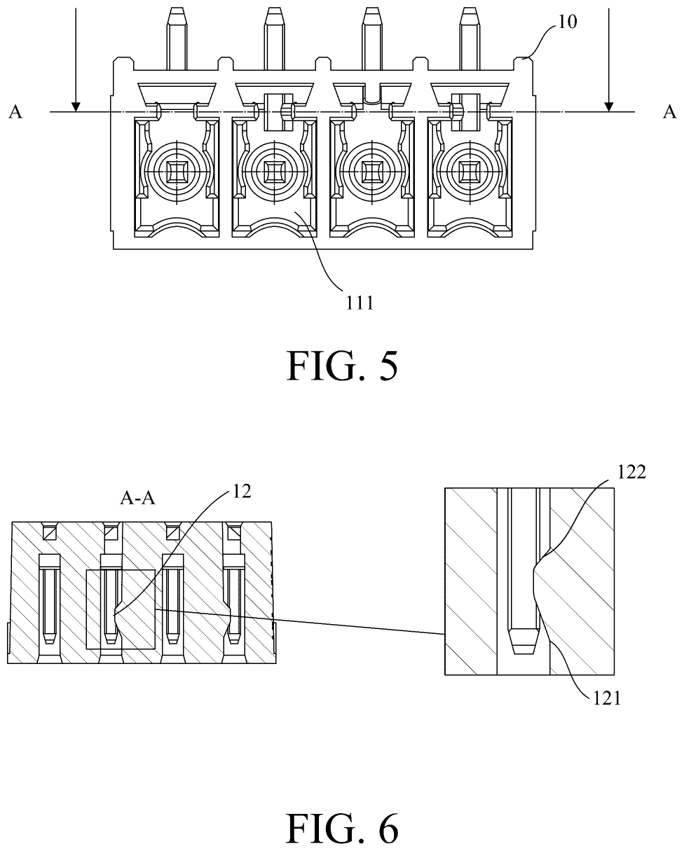

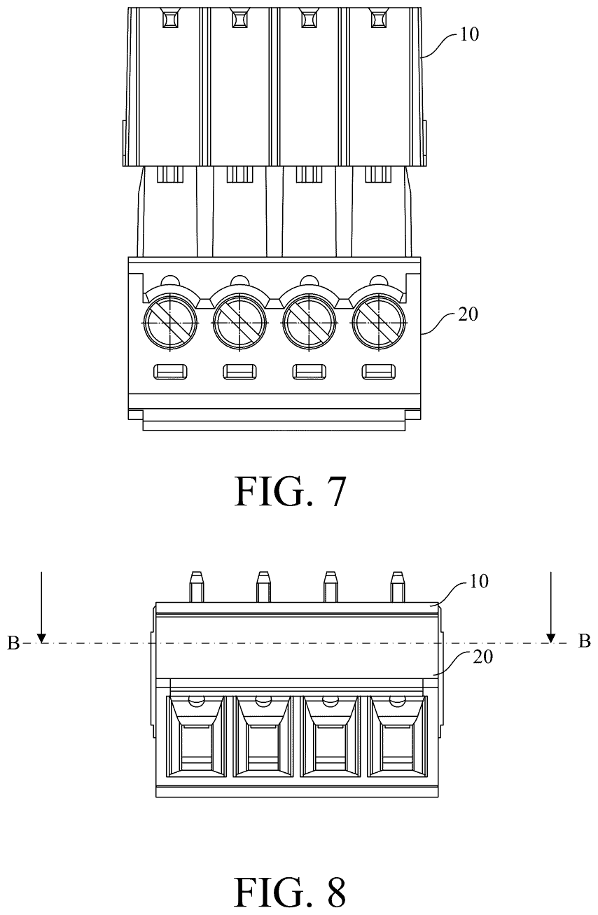

FIG. 5 illustrates a front view of a connector socket 10 in accordance with one or more embodiments of the present disclosure. FIG. 6 illustrates a section view along the A-A line in FIG. 5 illustrating a connector socket 10 in accordance with one or more embodiments of the present disclosure. As shown in FIGS. 5-6, the connector socket 10 includes a retention protrusion 12, and the retention protrusion 12 includes a lead-in surface 121 and a lead-out surface 122. The lead-in surface 121 is configured to lead insertion of the locking protrusion 21 to make the locking protrusion 21 deform around the retention protrusion 12, and the lead-out surface 122 is configured to interfere with the locking protrusion 21 to retain a connector plug in the internal cavity 111. A detailed insertion process of the connector plug is illustrated in FIGS. 7-15.

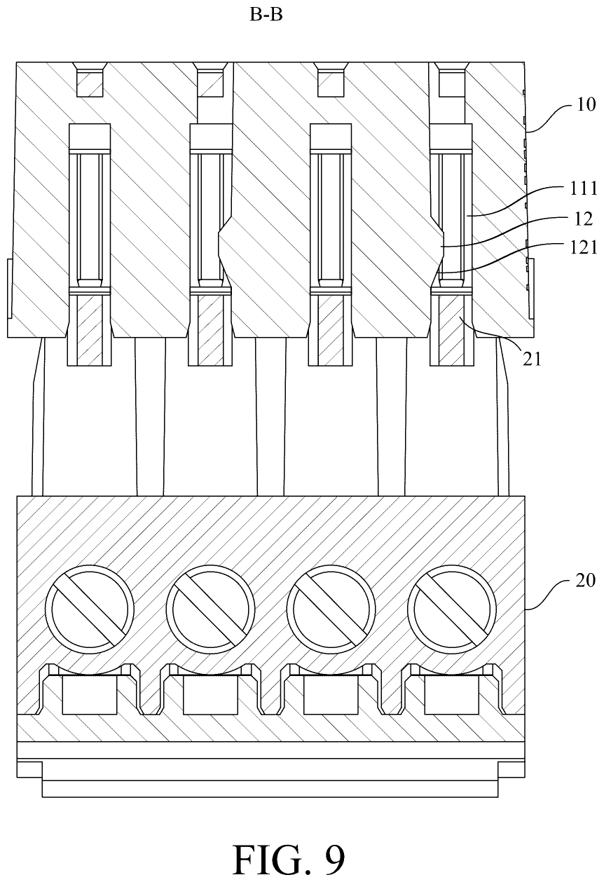

FIGS. 7-8 respectively illustrate a top view and a front view of a connector without the insertion of the connector plug 20 in accordance with one or more embodiments of the present disclosure. FIG. 9 illustrates a section view along the B-B line in FIG. 8 illustrating a connector without the insertion of the connector plug 20 in accordance with one or more embodiments of the present disclosure. As shown FIGS. 7-9, when the connector plug 20 is to be inserted into the internal cavity 111 of the connector socket 10, the head of the locking protrusion 21 of the connector plug 20 contacts the lead-in surface 121 of the retention protrusion 12, and is led by the lead-in surface 121 to slip into the internal cavity 111 of the connector socket 10.

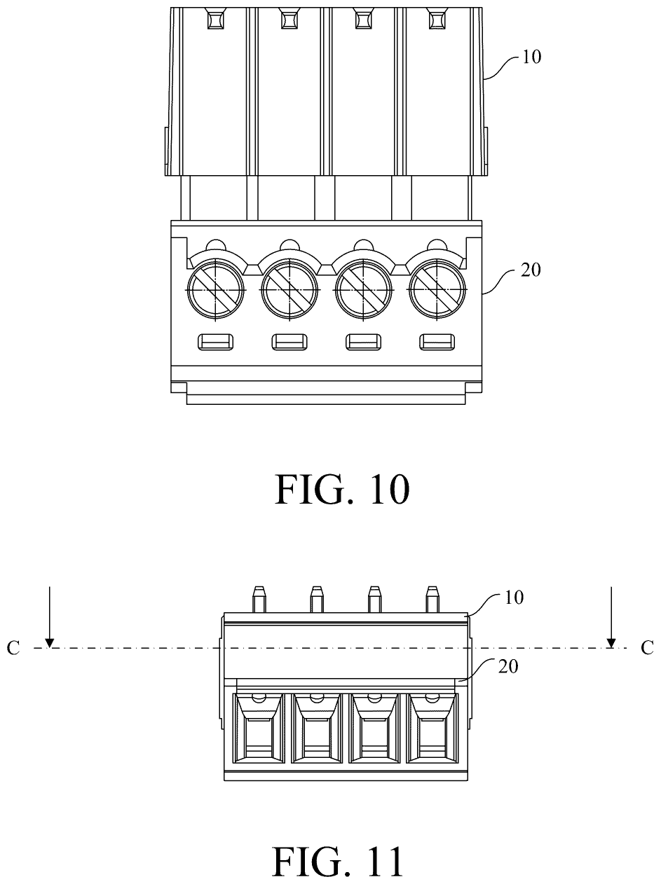

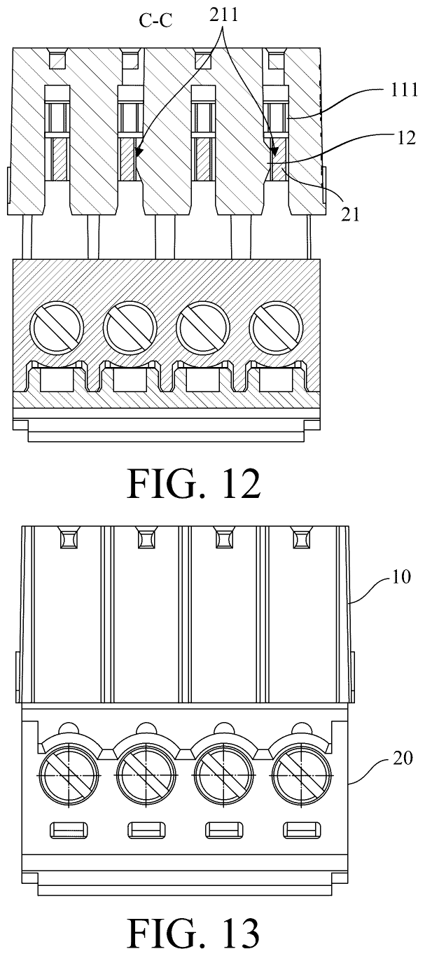

FIGS. 10-11 respectively illustrate a top view and a front view of a connector with the connector plug 20 partially inserted into the connector socket 10 in accordance with one or more embodiments of the present disclosure. FIG. 12 illustrates a section view along the C-C line in FIG. 11 illustrating a connector with the connector plug 20 partially inserted into the connector socket 10 in accordance with one or more embodiments of the present disclosure. As shown in FIGS. 10-12, when the connector plug 20 is being inserted into the internal cavity 111 of the connector socket 10, the head of the locking protrusion 21 of the connector plug 20 is led into the internal cavity 111, and a side surface of the locking protrusion 21 will interfere with the retention protrusion 12, such that deformation is formed on the connector plug 20 or the connector socket 10, for example, the locking protrusion 21 deforming around the retention protrusion 12, allowing the locking protrusion 21 to continue to slip into the internal cavity 111 of the connector socket 10.

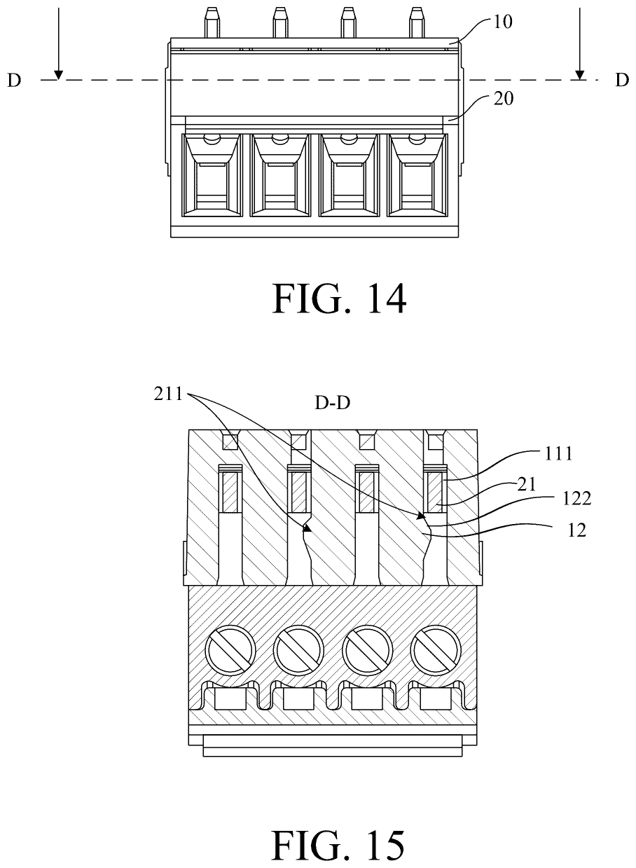

FIGS. 13-14 respectively illustrate a top view and a front view of a connector with the connector plug 20 fully inserted into the connector socket 10 in accordance with one or more embodiments of the present disclosure. FIG. 15 illustrates a section view along the D-D line in FIG. 14 illustrating a connector with the connector plug 20 fully inserted into the connector socket 10 in accordance with one or more embodiments of the present disclosure. As shown in FIGS. 13-15, when the connector plug 20 has been inserted into the internal cavity 111 of the connector socket 10, the locking protrusion 21 of the connector plug 20 has been fully led into the internal cavity 111, and the stress created by the interference of the locking protrusion 21 and the retention protrusion 12 has been released, such that the deformation formed on the connector plug 20 or the connector socket 10 is released, for example, the locking protrusion 21 snapping back once passing the retention protrusion 12. In this case, the locking protrusion 21 is blocked by the lead-out surface 122 of the retention protrusion 12, such that the connector plug 20 cannot be extracted from the connector socket 10. When an extracting force is applied to the connector plug 20, unless the extracting force is great enough to overcome the friction between the locking protrusion 21 and the lead-out surface 122, the connector plug 20 cannot be pulled out from the connector socket 10. In some embodiments, the extracting force has to resist at least 5 g to 30 g in applied shock. However, the extracting force required for extracting the connector plug 20 is not limited to the embodiments of the present disclosure.

In some embodiments, as shown in FIG. 6, the shape of the retention protrusion 12 facilitates the insertion of the connector plug 20 and prevents the extraction of the connector plug 20, in that the lead-in surface 121 may have a smaller angle relative to an insertion direction of the locking protrusion 21 than the lead-out surface 122, such that the connector plug 20 can more easily slip into the internal cavity 111 of the connector socket 10, and be more difficult to remove from the internal cavity 111. In some embodiments, the lead-in surface 121 may have a 30° angle relative to the insertion direction of the locking protrusion 21, and the lead-out surface 122 may have a 40° angle relative to the insertion direction of the locking protrusion 21. However, the detailed angles relative to the insertion direction are not limited to the embodiments of the present disclosure.

In some embodiments, the retention protrusion 12 is configured to interfere with a side surface of the locking protrusion 21, as shown in FIGS. 5-15. However, in some other embodiments, the retention protrusion 12 may be configured to interfere with a top surface of the locking protrusion 21. The location in the internal cavity 111 and the interfering manner of the retention protrusion 12 are not limited to the embodiments of the present disclosure.

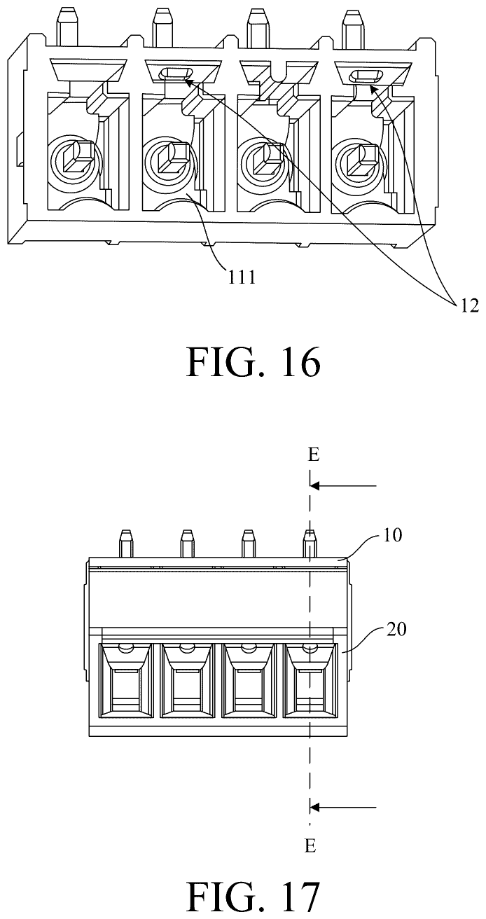

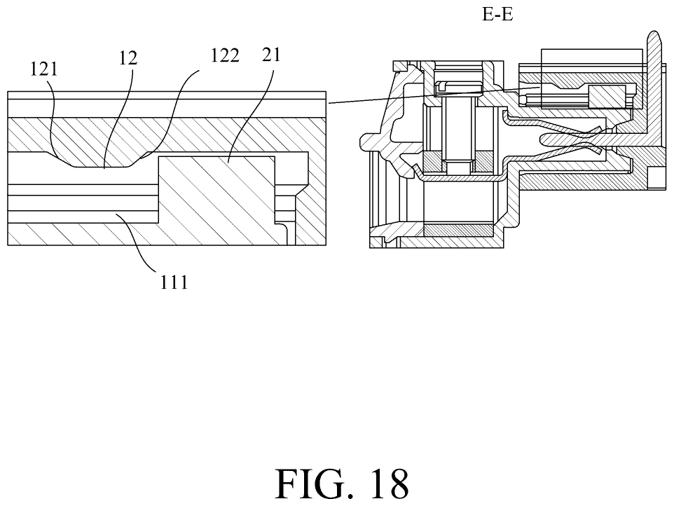

FIG. 16 is a perspective view of a connector socket 10 in accordance with one or more embodiments of the present disclosure. FIG. 17 is a front view of a connector with the connector plug 20 fully inserted into the connector socket 10 in accordance with one or more embodiments of the present disclosure. FIG. 18 is a section view along the E-E line in FIG. 17 illustrating a connector with the connector plug 20 fully inserted into the connector socket 10 in accordance with one or more embodiments of the present disclosure. As shown in FIGS. 16-18, the retention protrusion 12 is disposed on a top surface of the internal cavity 111. In this case, the retention protrusion 12 will interfere with the top surface of the locking protrusion 21 when the connector plug 20 is inserted.

In some embodiments, the connector socket 10 may include multiple internal cavities 111, configured to mate with multiple connector plugs 20, respectively. The retention protrusion 12 is located in at least one of the multiple internal cavities 111. For example, as shown in FIGS. 5-15, four internal cavities are included in the connector socket 10, and each internal cavity 111 is configured to mate with a connector plug 20. However, only the second and the fourth internal cavities of the connector socket 10 have retention protrusions 12. In some embodiments, the multiple connector plugs 20 may be arranged side by side and manufactured as an integrated unit. However, the number of the multiple internal cavities 111 or the connector plugs 20, the number of the retention protrusions 12, and the location arrangement of the retention protrusions 12 in the multiple internal cavities 111 are not limited to the embodiments of the present disclosure.

In some embodiments, each of the multiple connector plugs 20 includes a locking protrusion 21, the multiple internal cavities 111 include at least one pair of internal cavities and at least one pair of retention protrusions 12 are located in the at least one pair of internal cavities, and each pair of the at least one pair of retention protrusions 12 are configured to interfere with opposite sides 211 of the locking protrusion 21. For example, as shown in FIG. 12 or 15, one pair of internal cavities have one pair of retention protrusions 12. One retention protrusion 12 of the pair of retention protrusions 12 is configured to interfere with a left side of the locking protrusion 21, and the other retention protrusion 12 of the pair of retention protrusions 12 is configured to interfere with a right side of the locking protrusion 21. By interfering with opposite sides 211 of locking protrusion 21, the retention forces can be applied to the locking protrusion 21 by the connector socket 10 from two opposite directions, such that the retention forces conducted by the connector socket 10 can be balanced, which can further avoid stress concentration, improve durability, and increase retention force compared to a single retention protrusion 12 and locking protrusion 21 because the connector interfaces are forced to remain central.

In some embodiments, the retention protrusions 12 may be evenly distributed in the multiple internal cavities 111, such that the retention forces can be applied to the locking protrusion 21 by the connector socket 10 from evenly distributed locations, such that the retention forces applied to the connector socket 10 are even and balanced, which can further avoid stress concentration and improve durability. In some embodiments, each pair of the at least one pair of retention protrusions 12 is spaced by an internal cavity 111 without a retention protrusion 12. For example, as shown in FIGS. 5-15, four internal cavities are included in the connector socket 10, only the second and the fourth internal cavities have retention protrusions 12, and the third internal cavity 111, which spaces the second internal cavity 111 and the fourth internal cavity 111, does not have a retention protrusion 12.

In some embodiments, the retention protrusion 12 is configured to conduct no stress on the connector plug 20 after insertion of the connector plug 20, which can further avoid stress concentration and improve durability. For example, the retention protrusion 12 can be disposed at a position inside the internal cavity 111 which enables the retention protrusion 12 to not be in contact with the locking protrusion 21 after the insertion of the connector plug 20, such that no stress is applied to the locking protrusion 21 after insertion of the connector plug 20. However, the detailed position of the retention protrusion 12 in the internal cavity 111 is not specifically limited in the present disclosure.

In some embodiments, the retention protrusion 12 is formed with the housing 11 as a whole unit. For example, the mold for manufacturing the housing 11 may be designed to include the mold structure corresponding to the retention protrusion 12, such that the retention protrusion 12 can be manufactured with the housing 11 as a whole unit. In some embodiments, compression molding or casting may be used for manufacturing the housing 11 of the connector socket 10. However, the manufacturing process of the connector socket 10 is not specifically limited in the present disclosure.

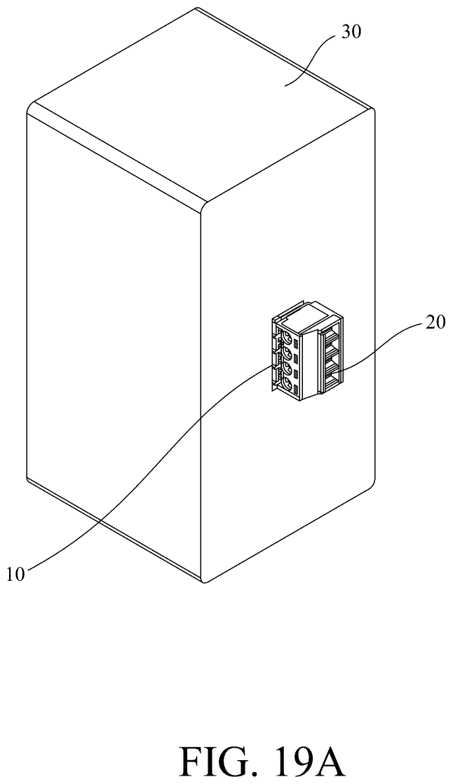

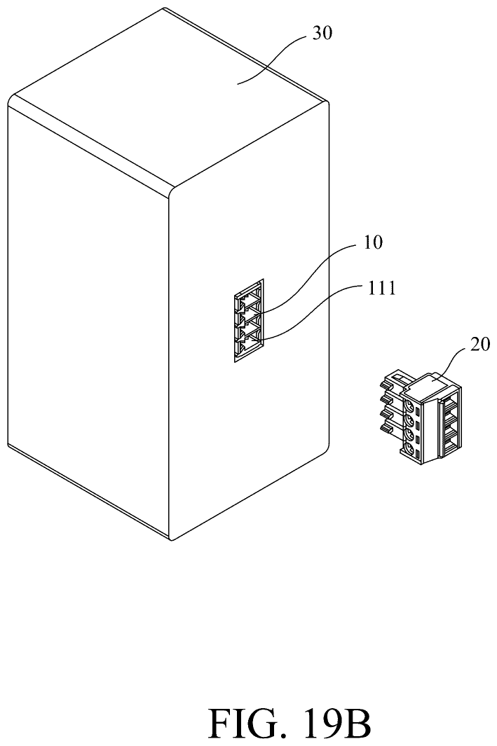

FIG. 19A is a perspective view of a device 30 with the connector plug 20 inserted into the connector socket 10 in accordance with one or more embodiments of the present disclosure. FIG. 19B is a perspective view of a device 30 with the connector plug 20 extracted from the connector socket 10 in accordance with one or more embodiments of the present disclosure. As shown in FIGS. 19A and B, the device 30 includes a connector, configured to connect to a cable for transmitting an electrical signal. The connector includes a connector plug 20 and a connector socket 10, the connector plug 20 being configured to connect with the cable and to be inserted into the connector socket 10 to form an electrical connection with the connector socket 10. The connector socket 10 includes a housing and a retention protrusion. The housing 11 comprises an internal cavity 111, configured to mate with the connector plug 20, and the retention protrusion 12 interferes with the connector plug 20 to retain the connector plug 20 in the internal cavity 111. In some embodiments, the device 30 may be used in an electrical or mechanical system for transferring power, signal, or data, for example, may be a panel-mounted device 30, such as a motor starter or some other kind of power controller. However, the type of the device 30 is not specifically limited in the present disclosure.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

Unless specifically stated otherwise, an order of steps of the method according to the present disclosure is only intended to be illustrative, and the steps of the method according to the present disclosure are not limited to the order specifically described above, but may be changed according to practical conditions. In addition, at least one of the steps of the method according to the present disclosure may be adjusted, combined or deleted according to practical requirements.

The examples were chosen and described in order to explain the principles of the disclosure and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

What is claimed is:

1. A connector socket, comprising:
a housing that comprises an internal cavity, wherein the internal cavity is configured to mate with a connector plug, and wherein the connector plug is configured to be inserted into the internal cavity to form an electrical connection with the connector socket, and
a retention protrusion, configured to interfere with the connector plug to retain the connector plug in the internal cavity.

2. The connector socket of claim 1, wherein the connector plug comprises a locking protrusion, and the retention protrusion comprises a lead-in surface and a lead-out surface,
the lead-in surface is configured to lead insertion of the locking protrusion to make the locking protrusion deform around the retention protrusion, and
the lead-out surface is configured to interfere with the locking protrusion to retain the connector plug in the internal cavity.

3. The connector socket of claim 2, wherein the lead-in surface has a smaller angle relative to an insertion direction of the locking protrusion than the lead-out surface.

4. The connector socket of claim 3, wherein the lead-in surface has a 30° angle relative to the insertion direction of the locking protrusion, the lead-out surface has a 40° angle relative to the insertion direction of the locking protrusion.

5. The connector socket of claim 1, wherein the connector plug comprises a locking protrusion, and the retention protrusion is configured to interfere with a top surface or a side surface of the locking protrusion.

6. The connector socket of claim 1, comprising:
multiple internal cavities, configured to mate with multiple connector plugs, respectively,
wherein the retention protrusion is located in at least one of the multiple internal cavities.

7. The connector socket of claim 6, wherein each of the multiple connector plugs comprises a locking protrusion, the multiple internal cavities comprise at least one pair of internal cavities and at least one pair of retention protrusions are located in the at least one pair of internal cavities, and
each pair of the at least one pair of retention protrusions is configured to interfere with opposite sides of the locking protrusion.

8. The connector socket of claim 7, wherein each pair of the at least one pair of retention protrusions is spaced by an internal cavity without a retention protrusion.

9. The connector socket of claim 1, wherein the retention protrusion is configured to conduct no stress on the connector plug after insertion of the connector plug.

10. The connector socket of claim 1, wherein the retention protrusion is formed with the housing as a whole unit.

11. A connector, comprising:
a connector plug and a connector socket, the connector plug being configured to be inserted into the connector socket to form an electrical connection with the connector socket,
wherein the connector socket comprises:
a housing that comprises an internal cavity, wherein the internal cavity is configured to mate with the connector plug, and
a retention protrusion, configured to interfere with the connector plug to retain the connector plug in the internal cavity.

12. The connector of claim 11, wherein the connector plug comprises a locking protrusion, and the retention protrusion comprises a lead-in surface and a lead-out surface,
the lead-in surface is configured to lead insertion of the locking protrusion to make the locking protrusion deform around the retention protrusion, and
the lead-out surface is configured to interfere with the locking protrusion to retain the connector plug in the internal cavity.

13. The connector of claim 12, wherein the lead-in surface has a smaller angle relative to an insertion direction of the locking protrusion than the lead-out surface.

14. The connector of claim 13, wherein the lead-in surface has a 30° angle relative to the insertion direction of the locking protrusion, the lead-out surface has a 40° angle relative to the insertion direction of the locking protrusion.

15. The connector of claim 11, wherein the connector plug comprises a locking protrusion, and the retention protrusion is configured to interfere with a top surface or a side surface of the locking protrusion.

16. The connector of claim 11, comprising:
multiple internal cavities, configured to mate with multiple connector plugs, respectively,
wherein the retention protrusion is located in at least one of the multiple internal cavities.

17. The connector of claim 16, wherein each of the multiple connector plugs comprises a locking protrusion, the multiple internal cavities comprise at least one pair of internal cavities and at least one pair of retention protrusions are located in the at least one pair of internal cavities, and
each pair of the at least one pair of retention protrusions is configured to interfere with opposite sides of the locking protrusion.

18. The connector of claim 17, wherein each pair of the at least one pair of retention protrusions is spaced by an internal cavity without a retention protrusion.

19. The connector of claim 11, wherein the retention protrusion is configured to conduct no stress on the connector plug after insertion of the connector plug.

20. A device, comprising:
a connector, configured to connect to a cable for transmitting an electrical signal,
wherein the connector comprises:
a connector plug and a connector socket, the connector plug being configured to connect with the cable and to be inserted into the connector socket to form an electrical connection with the connector socket,
wherein the connector socket comprises:
a housing that comprises an internal cavity, wherein the internal cavity is configured to mate with the connector plug, and
a retention protrusion, configured to interfere with the connector plug to retain the connector plug in the internal cavity.
